(19) United States
(12) Patent Application Publication
(10) Pub. No.: US 2016/0043538 A1
(43) Pub. Date: Feb. 11, 2016

(54) ELECTROSTATIC DISCHARGE PROTECTION CIRCUIT, ELECTROSTATIC DISCHARGE PROTECTION METHOD AND VOLTAGE REGULATOR CHIP HAVING THE SAME

(71) Applicant: ACTRON TECHNOLOGY CORPORATION, Taoyuan (TW)

(72) Inventors: Der-Ju Hung, Taoyuan (TW); Chi-Kai Wu, Taoyuan (TW); Chien-Chih Lu, Taoyuan (TW)

(21) Appl. No.: 14/506,699

(22) Filed: Oct. 6, 2014

(30) Foreign Application Priority Data
Aug. 8, 2014 (TW) 103127234

(51) Int. Cl. H02H 3/20; H02H 7/00

(52) U.S. Cl. CPC H02H 3/20; H02H 7/00

(57) ABSTRACT

An electrostatic discharge (ESD) protection circuit, an ESD protection method, and a voltage regulator chip having the same are provided. The ESD protection circuit includes a turn-on voltage controller, an ESD protection switch and a control signal transporting path. The turn-on voltage controller is coupled to a pad, and generates a detection signal according to a voltage on the pad. The ESD protection switch is turned on according to a control signal for discharging an ESD current on the pad. The control signal transporting path is turned on according to the detection signal and generates the control signal by delaying the voltage on the pad according to a delay value.

### CROSS-REFERENCE TO RELATED APPLICATION

This application claims the priority benefit of Taiwan application serial no. 103127234, filed on Aug. 8, 2014. The entirety of the above-mentioned patent application is hereby incorporated by reference herein and made a part of this specification.

### BACKGROUND

1. Technical Field

The invention relates to an electrostatic discharge (ESD) protection circuit, and particularly relates to an ESD protection circuit in a chip.

2. Related Art

Along with continuous development of electronic technology, electronic products become indispensable tools in people's daily life, and in the electronic products, integrated circuit (IC) plays an important role. By constructing the IC, a circuit area of the electronic product can be greatly decreased. Moreover, the IC generally provides a high performance computation capability to improve a whole performance of the electronic product.

In the IC, how to implement electrostatic discharge (ESD) protection is always an important issue concerned by technicians of the related field. In the conventional technical field, a diode is generally used as a device for ESD protection in the chip at a position adjacent to a pad. Alternatively, in the conventional technical field, a transient voltage suppressor (TVS) externally connected to the chip is used for the ESD protection. However, in various methods of the conventional technique, when a large amount of ESD current is occurred, the ESD current probably cannot be completely drained and thus damage of the chip is caused.

Moreover, if the TVS is used as an external ESD protection device, since the TVS occupies a certain volume, difficulty in miniaturization of the IC is increased, and since the TVS is not only expensive, but is also unable to withstand a high temperature, there are may application bottlenecks, for example, in a vehicle electronics domain. Accordingly, an ESD protection technique capable of simultaneously withstanding high ESD and high temperature is required.

### SUMMARY

The invention is directed to an electrostatic discharge (ESD) protection circuit, which effectively improves an ESD protection level of a chip.

The invention provides an ESD protection circuit including a turn-on voltage controller, an ESD protection switch and a control signal transporting path. The turn-on voltage controller is coupled to a pad, and generates a detection signal according to a voltage on the pad. The ESD protection switch is coupled between the pad and a reference ground terminal, and is turned on according to a control signal to discharge an ESD current on the pad. The control signal transporting path is coupled between the pad and the ESD protection switch, and is coupled to the turn-on voltage controller. The control signal transporting path is turned on according to the detection signal and generates the control signal by delaying the voltage on the pad according to a delay value.

In an embodiment of the invention, a mode control circuit coupled to the turn-on voltage controller and the control signal transporting path is provided, which provides a switch coupled in series between a terminal of the turn-on voltage controller generating the detection signal and a reference ground voltage. The mode control circuit makes the detection signal to be equal to the reference ground voltage in a non-ESD mode, and isolates the reference ground voltage from the detection signal in an ESD mode.

In an embodiment of the invention, the mode control circuit includes a buffer. The buffer is coupled to a control terminal of the switch, and in the non-ESD mode, the switch is turned on in response to an output signal of the buffer, and in the ESD mode, the switch is turned off in response to the output signal of the buffer.

In an embodiment of the invention, the control signal transporting path includes an impedance provider and a switch. A first terminal of the impedance provider is coupled to the pad, a first terminal of the switch is coupled to a second terminal of the impedance provider, a control terminal of the switch receives the detection signal, and a second terminal of the switch generates the control signal.

In an embodiment of the invention, the delay value is determined according to an impendence provided by the impendence provider and a parasitic capacitance of the ESD protection switch.

In an embodiment of the invention, the turn-on voltage controller detects whether the voltage on the pad is greater than a threshold value, so as to generate the detection signal.

In an embodiment of the invention, the turn-on voltage controller includes a plurality of diodes. The diodes are connected in series to each other, an anode of the diode of a first stage is coupled to the pad, and a cathode of the diode of a last stage generates the detection signal, where the threshold value is a sum of breakover voltages of the diodes.

In an embodiment of the invention, the ESD protection switch is a transistor. The transistor has a first terminal, a second terminal and a control terminal, where the first terminal of the transistor is coupled to the pad, the control terminal of the transistor receives the control signal, and the second terminal of the transistor is coupled to the reference ground terminal.

In an embodiment of the invention, the transistor further has a base terminal, and the base terminal of the transistor is coupled to the reference ground terminal.

In an embodiment of the invention, when the transistor is turned on, channels are formed between the first terminal and the second terminal of the transistor and between the first terminal and the base terminal of the transistor to drain the ESD current on the pad.

The invention provides a voltage regulator chip, which includes the aforementioned ESD protection circuit, the voltage regulator chip is, for example, a voltage regulator chip of a vehicle generator, and the ESD protection circuit is coupled to a FR pad of the vehicle voltage regulator chip.

The invention provides an electrostatic discharge protection method for a chip having a pad, and the method comprises steps of: providing an electrostatic discharge protection switch coupled between the pad and a reference ground terminal; providing a control signal transporting path coupled between the pad and the electrostatic discharge protection switch; generating a detection signal according to a voltage on the pad; turning on the control signal transporting path according to the detection signal, and generating a control signal by delaying the voltage on the pad according to a delay value; and turning on the electrostatic discharge protection switch according to the control signal to discharge an electrostatic discharge current on the pad.

According to the above descriptions, the ESD protection circuit of the invention provides the turn-on voltage controller to generate a detection signal when an ESD phenomenon is occurred, and turns on the control signal transporting path according to the detection signal to transmit the control signal to the ESD protection switch. The control signal transporting path delays the voltage on the pad to generate the control signal, and the ESD protection switch is turned on according to the control signal to drain the ESD current. According to the above mechanism, the ESD switch is instantaneously turned on to avoid inrush of a large amount of the ESD current to cause damage. Therefore, the ESD protection circuit of the invention provides a higher protection level, and the chip satisfies a more stringent product demand.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an electrostatic discharge (ESD) protection circuit according to an embodiment of the invention.

FIG. 2 is a schematic diagram of an ESD protection circuit according to another embodiment of the invention.

FIG. 3 is a schematic diagram of an ESD protection circuit according to still another embodiment of the invention.

FIG. 4 is a schematic diagram of an implementation of a turn-on voltage controller 310 according to an embodiment of the invention.

FIG. 5 is a schematic diagram of an IC chip according to an embodiment of the invention.

### DETAILED DESCRIPTION OF DISCLOSED EMBODIMENTS

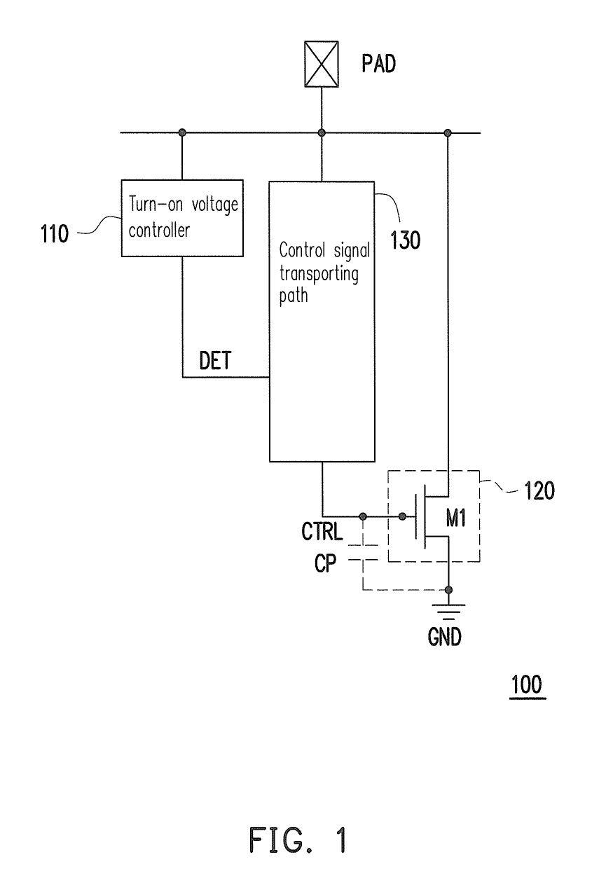

Referring to FIG. 1, which is a schematic diagram of an electrostatic discharge (ESD) protection circuit according to an embodiment of the invention. The ESD protection circuit 100 includes a turn-on voltage controller 110, an ESD protection switch 120 and a control signal transporting path 130. The turn-on voltage controller 110 is coupled to a pad PAD. The turn-on voltage controller 110 detects a voltage on the pad PAD, and generates a detection signal DET according to the voltage on the pad PAD. The control signal transporting path 130 is coupled between the pad PAD and a control terminal of the ESD protection switch 120. The control signal transporting path 130 receives the detection signal DET generated by the turn-on voltage controller 110. The control signal transporting path 130 is turned on according to the detection signal DET, and provides a control signal CTRL to the control terminal of the ESD protection switch 120 when the control signal transporting path 130 is turned on.

It should be noticed that when the control signal transporting path 130 is turned on according to the detection signal DET, the control signal transporting path 130 may generate the control signal CTRL by delaying the voltage on the pad PAD according to a delay value.

Regarding setting of the delay value, the control signal transporting path 130 can provide an impedance between the pad PAD and the control terminal of the ESD protection switch 120, and the delay value used for generating the control signal CTRL by the control signal transporting path 130 can be determined based on the impedance provided by the control signal transporting path 130 and a parasitic capacitance CP provided by the ESD protection switch 120.

The ESD protection switch 120 is coupled in series between the pad PAD and a reference ground terminal GND. The control terminal of the ESD protection switch 120 receives the control signal CTRL, and is turned on or turned off according to the control signal CTRL. When the ESD protection switch 120 is turned on according to the control signal CTRL, an ESD current on the pad PAD can be drained to the reference ground terminal GND through the ESD protection switch 120.

In the present embodiment, the ESD protection switch 120 is an N-type metal oxide semiconductor field effect transistor (MOSFET) M1. A first terminal (for example, a drain) of the transistor M1 is coupled to the pad PAD, a second terminal (for example, a source) of the transistor M1 is coupled to the reference ground terminal GND, and a control terminal (for example, a gate) of the transistor is coupled to the control signal transporting path 130 to receive the control signal CTRL.

Regarding a whole operation of the ESD protection circuit 100, when an ESD phenomenon is occurred on the pad PAD, the turn-on voltage controller 110 detects that the voltage on the pad PAD is higher than a predetermined threshold value, and accordingly generates the detection signal DET. The turn-on voltage controller 110 transmits the detection signal DET to the control signal transporting path 130 to turn on the control signal transporting path 130. The turned-on control signal transporting path 130 delays the voltage on the pad PAD according to the delay value, so as to generate the control signal CTRL.

It should be noticed that the delay operation performed by the control signal transporting path 130 is implemented according to an RC delay effect generated based on the impedance provided by the control signal transporting path 130 and the parasitic capacitance CP between the gate-source of the transistor M1. Namely, besides that the control signal transporting path 130 delays the voltage on the pad PAD, the control signal transporting path 130 also bucks the voltage on the pad PAD to generate the control signal CTRL. In this way, a voltage value of the control signal CTRL provided by the control signal transporting path 130 can be greatly decreased, so as to avoid damaging a gate oxide layer of the transistor M1.

The ESD protection switch 120 is turned on according to the control signal CTRL. When the ESD protection switch 120 is turned on, a path between the pad PAD and the reference ground terminal GND for draining the ESD current is provided.

It should be noticed, the ESD protection switch 120 is not turned on instantaneously when the ESD event is occurred on the pad PAD. Comparatively, in the present embodiment, the control signal CTRL used for controlling a conducting state of the ESD protection switch 120 is generated after a delay time after the ESD phenomenon is occurred on the pad PAD. Namely, the ESD protection switch 120 is gradually turned on after a certain time delay after the ESD phenomenon is occurred on the pad PAD, so as to gradually drain the ESD current of the pad PAD.

According to the aforementioned description, it is known that the transistor M1 is avoided to instantaneously take a large amount of the ESD current to cause a damage when the ESD phenomenon is occurred on the pad PAD. Comparatively, through a conduction delay of the transistor M1 of the present embodiment, the amount of the ESD current flowing through the transistor M1 is effectively controlled. In this way, the transistor M1 is avoided to be damaged, and the ESD current can be effectively drained, so as to greatly improve an ESD protection level of the chip.

A base of the transistor M1 of the present embodiment can be coupled to the reference ground terminal GND. In this way, when the transistor 1\41 is turned on, a channel between the drain and the source of the transistor M1 can serve as a drain path of the ESD current, and a channel between the drain and the base of the transistor M1 can also serve as the drain path of the ESD current.

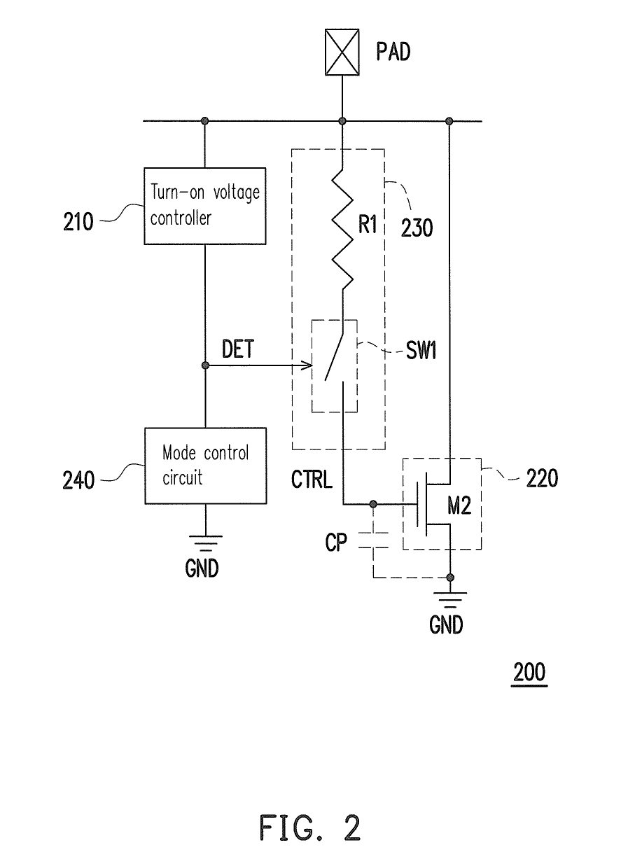

Referring to FIG. 2, FIG. 2 is a schematic diagram of an ESD protection circuit according to another embodiment of the invention. The ESD protection circuit 200 includes a turn-on voltage controller 210, and ESD protection switch 220, a control signal transporting path 230 and a mode control circuit 240. The turn-on voltage controller 210 is coupled to the pad PAD. The control signal transporting path 230 is coupled in series between the pad PAD and a control terminal of the ESD protection switch 220. The ESD protection switch 220 is coupled in series between the pad PAD and the reference ground terminal GND.

The control signal transporting path 230 includes an impedance provider R1 and a switch SW1. The impedance provider R1 can be a resistor, a first terminal of the impedance provider R1 is coupled to the pad PAD, and a second terminal of the impedance provider R1 is coupled to a first terminal of the switch SW1. A second terminal of the switch SW1 is coupled to the control terminal of the ESD protection switch 220, and a control terminal of the switch SW1 receives the detection signal DET, and is turned on or turned off according to the detection signal DET.

It should be noticed that different to the aforementioned embodiment, the ESD protection circuit 200 of the present embodiment further includes the mode control circuit 240. The mode control circuit 240 is coupled to the turn-on voltage controller 210 and the control signal transporting path 230. The mode control circuit 240 provides a switch (not shown) coupled in series between a terminal of the turn-on voltage controller 210 generating the detection signal DET and the reference ground voltage GND. The mode control circuit 240 makes the detection signal DET to be equal to a reference ground voltage on the reference ground terminal GND in a non-ESD mode, and isolates the reference ground voltage from the detection signal DET in an ESD mode.

Regarding an actual operation of the ESD protection circuit 200, in the non-ESD mode, the mode control circuit 240 couples the detection signal DET to the reference ground terminal GND, such that the voltage value of the detection signal DET is pulled down to be equal to the reference ground voltage (for example, 0 volt). In such mode, the control signal transporting path 230 is not turned on, and the control signal CTRL is not provided to turn on the ESD protection switch 220. Namely, the ESD protection circuit 200 is not turned on to implement the ESD protection, and the chip where the ESD protection circuit 200 belongs to can normally operate.

Comparatively, in the ESD mode, the path that the detection signal DET is coupled to the reference ground terminal GND is cut off by the mode control circuit 240, and the voltage level of the detection signal DET is varied according a detection result obtained when the turn-on voltage controller 210 detects the voltage on the pad PAD. Namely, in such mode, when the ESD phenomenon is occurred on the pad PAD, the ESD protection circuit 200 can effectively implement the ESD protection.

It should be noticed that the delay value provided by the control signal transporting path 230 can be determined according to an impedance of the impedance provider R1 and a parasitic capacitance CP between the gate and the source of the transistor M2, and it is unnecessary to additionally configure a physical capacitor. Certainly, if necessary, the additional physical capacitor can also be configured between the gate and the source of the transistor M2 to increase the delay value.

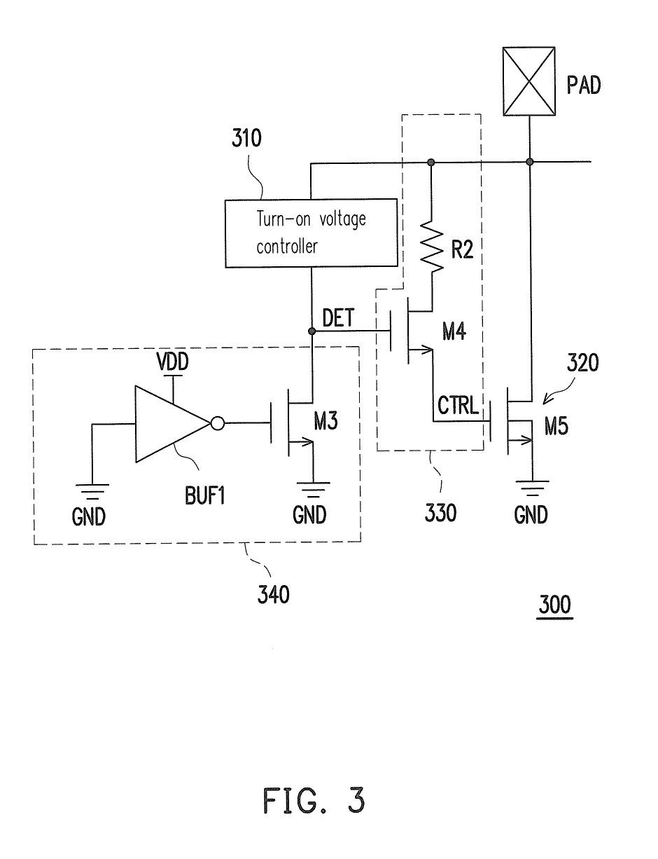

Referring to FIG. 3, FIG. 3 is a schematic diagram of an ESD protection circuit according to still another embodiment of the invention. The ESD protection circuit 300 includes a turn-on voltage controller 310, an ESD protection switch 320, a control signal transporting path 330 and a mode control circuit 340. The control signal transporting path 330 includes an impedance provider R2 and a switch folined by a transistor M4. In the present embodiment, the transistor M4 can be an N-type MOSFET, and can be turned on when the received detect signal DET has a logic high level. The ESD protection switch 320 is implemented by a transistor M5, and it should be noticed that a base and a source of the transistor M5 are connected to each other.

Moreover, the mode control circuit 340 includes a buffer BUF1 and a switch implemented by a transistor M3. A first terminal and a second terminal of the transistor M3 are respectively coupled to a terminal of the turn-on voltage controller 310 providing the detection voltage DET and the reference ground terminal GND. A control terminal of the transistor M3 is coupled to an output terminal of the buffer BUF1. In the present embodiment, the transistor M3 can be an N-type MOSFET. An input terminal of the buffer BUF1 receives a power voltage VDD to serve as an operation voltage. In the present embodiment, the buffer BUF1 is an inverter.

In the ESD mode, the power voltage VDD is coupled to the reference ground terminal GND. Therefore, the transistor M3 is turned off, and the detection signal DET is not pulled down to the reference ground voltage. Comparatively, in the non-ESD mode, the power voltage VDD is a normal voltage used by the chip, and in this case, the output terminal of the buffer BUF1 outputs a signal with a logic high level to turn on the transistor M3. Therefore, the detection signal DET is pulled down to be equal to the reference ground voltage, and the ESD protection circuit 300 is not activated.

It should be noticed that besides a normal operation mode, the non-ESD mode further includes a test mode. In the test mode, a test voltage with a higher voltage value (for example, 24V) is provided to the pad PAD, and the turn-on voltage controller 310 detects that the voltage value of the test voltage is not greater than a threshold value, and does not generate the detection signal DET according to the test voltage. On the other hand, the buffer BUF1 of the mode control circuit 340 receives the power voltage VDD with a value of, for example, 3.3V, and the output terminal of the buffer BUF1 provides a signal to turn on the transistor M3. In this way, the voltage value of the detection signal DET is pulled down to be equal to the reference ground voltage, such that the transistor M4 is turned off.

According to the above descriptions, it is known that in the test mode, the test operation can be performed by providing the test voltage (for example, 24V) on the pad PAD.

It should be noticed that the threshold value set in the turn-on voltage controller 310 can be greater than the test voltage, and in the present embodiment, the threshold value is, for example, 30V.

Based on the configuration of the ESD protection circuit 300 of FIG. 3, in an actual chip test, the chip may reach a level of 16-18 KV under the ESD test of a human body mode (HBM), by which the ESD protection level of the chip is greatly improved.

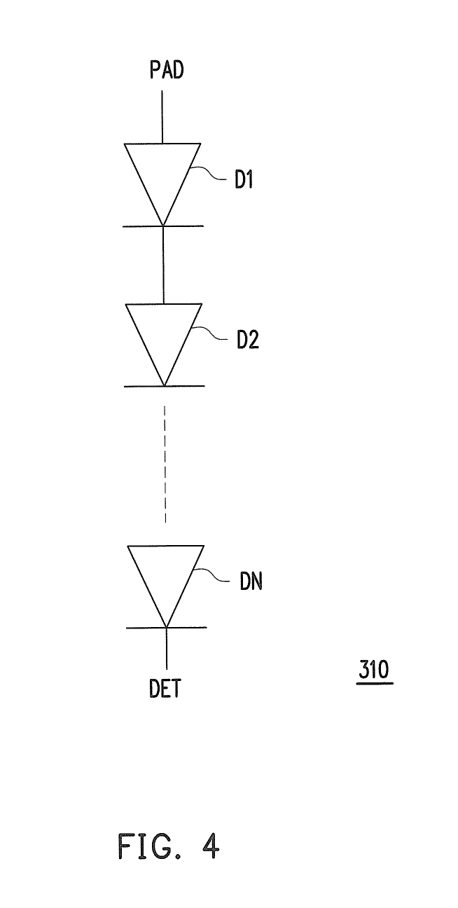

Referring to FIG. 4, FIG. 4 is a schematic diagram of an implementation of the turn-on voltage control 310 according to an embodiment of the invention. The turn-on voltage controller 310 includes a plurality of diodes D1-DN. The diodes D1-DN are connected in series to form a diode string. An anode of the diode D1 of a first stage is coupled to the pad PAD, a cathode of the diode D1 of the first stage is coupled to an anode of the second diode D2 of a second stage, and a cathode of the diode D2 of the second stage is coupled to an anode of the diode of a next stage. Deduced by analogy, a cathode of the diode N of the last stage generates the detection signal DET.

In the present embodiment, a magnitude of the threshold value used for generating detection signal DET by the turn-on voltage controller 310 is equal to a sum of breakover voltages, also known as threshold voltages (Vt), of the diodes D1-DN.

A number of the diodes D1-DN can be set according to an actual working state of the chip and a magnitude of the threshold voltage of a single diode, which is not limited by the invention.

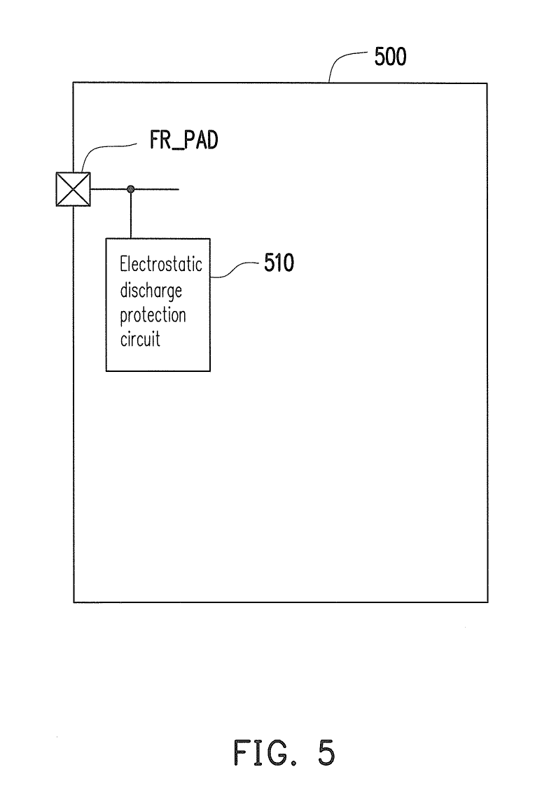

Referring to FIG. 5, FIG. 5 is a schematic diagram of an IC chip according to an embodiment of the invention. The ESD protection circuit of the invention can be applied in various IC chips requiring an ESD protection design, and the chip is, for example, an voltage regulator chip 500 of a vehicle generator. For example, an ESD protection circuit 510 is coupled to an FR pad or other pad terminals of the voltage regulator chip 500 to achieve the ESD protection effect. According to the descriptions of the aforementioned embodiments, based on the setting of the threshold value in the turn-on voltage controller, the ESD protection level of the chip can be arbitrarily adjusted according to an actual product requirement. The structure and operation details of the ESD protection circuit 510 have been described in detail in the aforementioned embodiment, so that details thereof are not repeated.

Certainly, in the present embodiment, the other pad terminals in the voltage regulator chip 500 can also be coupled to the ESD protection circuit 510 to improve the ESD protection level thereof.

In summary, the turn-on voltage controller is used to detect whether the ESD phenomenon is occurred, and when the ESD phenomenon is occurred, the control signal transporting path generates the control signal to turn on the ESD protection switch. Generation of the control signal can be suitably delayed. Therefore, the ESD protection switch can reduce a current value of the transiently received ESD current, so as to decrease a chance of damaging the ESD protection switch. In this way, the ESD protection switch can safely provide an ESD current draining capability, so as to improve the ESD protection level of the chip.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An electrostatic discharge protection circuit, comprising:
a turn-on voltage controller, coupled to a pad, and generating a detection signal according to a voltage on the pad;
an electrostatic discharge protection switch, coupled between the pad and a reference ground terminal, and being turned on according to a control signal to discharge an electrostatic discharge current on the pad; and
a control signal transporting path, coupled between the pad and the electrostatic discharge protection switch, and coupled to the turn-on voltage controller, wherein the control signal transporting path is turned on according to the detection signal and generates the control signal by delaying the voltage on the pad according to a delay value.

2. The electrostatic discharge protection circuit as claimed in claim 1, further comprising:
a mode control circuit, coupled to the turn-on voltage controller and the control signal transporting path, and providing a switch coupled in series between a terminal of the turn-on voltage controller generating the detection signal and a reference ground voltage, wherein the mode control circuit makes the detection signal to be equal to the reference ground voltage in a non-electrostatic discharge mode, and isolates the reference ground voltage from the detection signal in an electrostatic discharge mode.

3. The electrostatic discharge protection circuit as claimed in claim 2, wherein the mod control circuit comprises:
a buffer, coupled to a control terminal of the switch, wherein in the non-electrostatic discharge mode, the switch is turned on in response to an output signal of the buffer, and in the electrostatic discharge mode, the switch is turned off in response to the output signal of the buffer.

4. The electrostatic discharge protection circuit as claimed in claim 1, wherein the control signal transporting path comprises:
an impedance provider, having a first terminal coupled to the pad; and
a switch, having a first terminal coupled to a second terminal of the impedance provider, a control terminal receiving the detection signal, and a second terminal generating the control signal.

5. The electrostatic discharge protection circuit as claimed in claim 4, wherein the delay value is determined according to an impendence provided by the impendence provider and a parasitic capacitance of the electrostatic discharge protection switch.

6. The electrostatic discharge protection circuit as claimed in claim 1, wherein the turn-on voltage controller detects whether the voltage on the pad is greater than a threshold value to generate the detection signal.

7. The electrostatic discharge protection circuit as claimed in claim 6, wherein the turn-on voltage controller comprises:
a plurality of diodes, connected in series to each other, wherein an anode of the diode of a first stage is coupled to the pad, and a cathode of the diode of a last stage generates the detection signal,
wherein the threshold value is a sum of breakover voltages of the diodes.

8. The electrostatic discharge protection circuit as claimed in claim 1, wherein the electrostatic discharge protection switch is a transistor, the transistor has a first terminal, a second terminal and a control terminal, wherein the first terminal of the transistor is coupled to the pad, the control terminal of the transistor receives the control signal, and the second terminal of the transistor is coupled to the reference ground terminal.

9. The electrostatic discharge protection circuit as claimed in claim 8, wherein the transistor further has a base terminal, and the base terminal of the transistor is coupled to the reference ground terminal.

10. The electrostatic discharge protection circuit as claimed in claim 9, wherein when the transistor is turned on, channels are formed between the first terminal and the second terminal of the transistor and between the first terminal and the base terminal of the transistor to drain the electrostatic discharge current on the pad.

11. A voltage regulator chip, comprising the electrostatic discharge protection circuit as claimed in the claim 1.

12. The voltage regulator chip as claimed in claim 11, being a voltage regulator chip of a vehicle generator and having an FR pad, wherein the electrostatic discharge protection circuit is coupled to the FR pad.

13. The voltage regulator chip as claimed in claim 11, wherein the voltage regulator chip has an electrostatic discharge protection capability greater than 15 KV.

14. An electrostatic discharge protection method for a chip having a pad, the method comprising steps of:
providing an electrostatic discharge protection switch coupled between the pad and a reference ground terminal;
providing a control signal transporting path coupled between the pad and the electrostatic discharge protection switch;
generating a detection signal according to a voltage on the pad;
turning on the control signal transporting path according to the detection signal, and generating a control signal by delaying the voltage on the pad according to a delay value; and
turning on the electrostatic discharge protection switch according to the control signal to discharge an electrostatic discharge current on the pad.

15. The electrostatic discharge protection method as claimed in claim 14, further comprising steps of:
providing an impedance provider coupled to the pad; and
determining the delay value according to an impendence provided by the impendence provider and a parasitic capacitance of the electrostatic discharge protection switch.

16. The electrostatic discharge protection method as claimed in claim 14, wherein the step of generating the detection signal includes a step of:
detecting whether the voltage on the pad is greater than a threshold value to generate the detection signal.

17. The electrostatic discharge protection method as claimed in claim 14, wherein the chip is a voltage regulator chip of a vehicle generator.

18. The electrostatic discharge protection method as claimed in claim 17, wherein the pad is an FR pad of the voltage regulator chip.

19. The electrostatic discharge protection method as claimed in claim 14, wherein the electrostatic discharge current is greater than 15 KV.
